(19) United States
(12) Patent Application Publication
(10) Pub. No.: US 2011/0229281 A1
(43) Pub. Date: Sep. 22, 2011

(54) Cutting Tool for Drilling

(75) Inventor: Min Gu Kim, Daegu (KR)

(73) Assignee: TaeguTec, Ltd., Dalsung-gun, Daegu 711-860 (KR)

(21) Appl. No.: 13/129,780

(22) PCT Filed: Oct. 16, 2009
(86) PCT No.: PCT/KR2009/005972

§ 371 Date: May 17, 2011

(30) Foreign Application Priority Data
Nov. 18, 2008 (KR) 10-2008-0114894

(51) Int. Cl. B23B 51/02

(52) U.S. Cl. 408/229

(57) ABSTRACT

A cutting tool for drilling has cutting inserts in the same shape and is capable of discharging a chip in a chip flute. The cutting tool includes: a body having a lower end facing a direction of drilling, a central axis of rotation and at least two chip flutes; and indexable inner and outer cutting inserts each disposed in an insert pocket formed at the lower end of the body and at a forward end of a corresponding chip flute. The inner cutting insert is located closer to the central axis of the body than the outer cutting insert. The inner and outer cutting inserts have the same shape and include lower cutting edges for depth cutting during drilling. The lower cutting edge of the inner cutting insert is disposed lower than the lower cutting edge of an imaginary cutting insert at a position where the inner cutting insert is overlapped with the imaginary cutting insert where the outer cutting insert is rotated by approximately a half-turn relative to the central axis.

### TECHNICAL FIELD

The present invention generally relates to a cutting tool for drilling. More particularly, the present invention relates to a cutting tool for drilling, which has inner and outer indexable cutting inserts disposed in an insert pocket formed at an end of a chip flute.

### BACKGROUND ART

Typically, drills may be divided into a solid-type drill and a throwaway-type drill depending on whether a cutting edge is integrally or separately formed with a drill body. Specifically, the throwaway-type drill is provided with indexable cutting inserts disposed in an insert pocket formed at an end of the drill body. In the throwaway-type drill, the cutting inserts are symmetrically or non-symmetrically mounted relative to a central axis of the drill body.

FIGS. 1 and 2 illustrate a conventional throwaway-type drill in which cutting inserts are non-symmetrically mounted relative to the central axis of the drill body. As shown in FIG. 1, the drill 1 is provided with an inner cutting insert 3 located close to the central axis 7 of the drill body and an outer cutting insert 5 that is located away therefrom. FIG. 2 is a front view illustrating one end of the drill shown in FIG. 1. FIG. 2 shows an imaginary cutting insert 5′ located in a position where the outer cutting insert 5 is rotated by approximately a half turn relative to the central axis 7. For ease of explanation, FIG. 2 ignores the amount by which the drill body proceeds for drilling in a vertical direction when the outer cutting insert 5 is rotated. As shown in FIG. 2, the imaginary cutting insert 5′ of the outer cutting insert 5 has a portion, which is partially overlapped with the inner cutting insert 3.

As shown in FIG. 2, in the overlapped portion, a lower cutting edge 10 of the inner cutting insert 3 and a lower cutting edge 9 of the imaginary cutting insert 5′ cross each other. As such, the lower cutting edge 10 of the inner cutting insert 3 produces two strips of chips in one flute for discharging cutting chips by the inner cutting insert 3 during a cutting process. The box 11 with slanted lines shown under the cutting insert in FIG. 2 schematically illustrates that two strips of chips are produced. That is, in the prior art, the two strips of chips are produced due to the cross configuration shown in FIG. 2 when the inner cutting insert passes the cutting surface, which the outer cutting insert has already passed. This is typically the case for flutes used for discharging cutting chips by the outer cutting insert 5.

During a drilling process, it is desirable that one strip of chip is produced in one flute. If two or more strips of chips are produced in one flute, then a smooth discharge of chips cannot occur, which usually results in an unstable drilling. This is especially the case when drilling mild steels, which cannot be cut easily.

### DISCLOSURE OF INVENTION

### Technical Problem

It is an object of the present invention to provide a cutting tool for drilling in which cutting inserts with the same shape are used and one strip of chip is produced in one chip flute, thereby solving the above-described problem of the prior art.

It is another object of the present invention to provide a cutting tool for drilling that can achieve a more stable drilling by using inner and outer cutting inserts with same chip widths.

### Technical Solution

In order to achieve the above objects, the present invention provides a cutting tool for drilling, comprising: a body including chip flutes; and indexable inner and outer cutting inserts disposed in an insert pocket formed at an end of the chip flute. The inner cutting insert is located close to a central axis of the body compared to the outer cutting insert. The inner and outer cutting inserts have the same shape and include a lower cutting edge disposed in a direction where the body proceeds during drilling. The inner cutting insert is overlapped with an imaginary cutting insert located in a position where the outer cutting insert is rotated by approximately a half turn relative to the central axis. In the overlapped portion, the lower cutting edge of the inner cutting insert is disposed in a lower position than that of the imaginary cutting insert. The lowest portion of the lower cutting edge is disposed by approximately one quarter of a drill diameter away from the central axis in a radial direction of the body.

Further, in the cutting tool for drilling according to the present invention, the lower cutting edge of the inner cutting insert is slanted towards the proceeding direction of the body relative to the radial direction of the body. The angle by which the lower cutting edge of the inner cutting insert is slanted is preferably about 0° to 10° relative to a horizontal plane.

Furthermore, in the cutting tool for drilling according to the present invention, the inner cutting insert is disposed to have a negative axial angle relative to an axis parallel to the central axis. The negative axial angle of the inner cutting insert is preferably is about 0° to 10°.

Also, in the cutting tool for drilling according to the present invention, a portion of the inner cutting insert is disposed beyond the central axis of the body. The cutting insert comprises: a generally rectangular parallel-piped shape; upper and lower surfaces which a clamping screw passes through; and four side surfaces for connecting the upper surface to the lower surface. Recesses are formed at certain portions of the side surfaces. More specifically, the recesses are formed at the portions of the side surfaces, which are disposed beyond the central axis of the body.

### ADVANTAGEOUS EFFECTS

The present invention provides a cutting tool for drilling, wherein cutting inserts with the same shape are used and one strip of chip is produced in a throwaway type drill including cutting inserts non-symmetrically mounted relative to a central axis of the drill body.

Moreover, the present invention provides a cutting tool for drilling, which ensures a more stable drilling by substantially equalizing the width of the chip by the inner cutting insert and the width of the chip by the outer cutting insert.

### BRIEF DESCRIPTION OF DRAWINGS

FIG. 1 is a perspective view illustrating a conventional drill.

FIG. 2 is a front view illustrating one end of the drill shown in FIG. 1.

FIG. 3 is a front view illustrating one end of the drill constructed in accordance with one embodiment of the present invention.

FIG. 4 is an enlarged view illustrating an inner cutting insert mounted to the drill shown in FIG. 3.

FIG. 5 is a cross-sectional view illustrating a drill taken along the line “A-A” from the drill shown in FIG. 4.

FIG. 6 is a perspective view illustrating a drill constructed in accordance with another embodiment of the present invention.

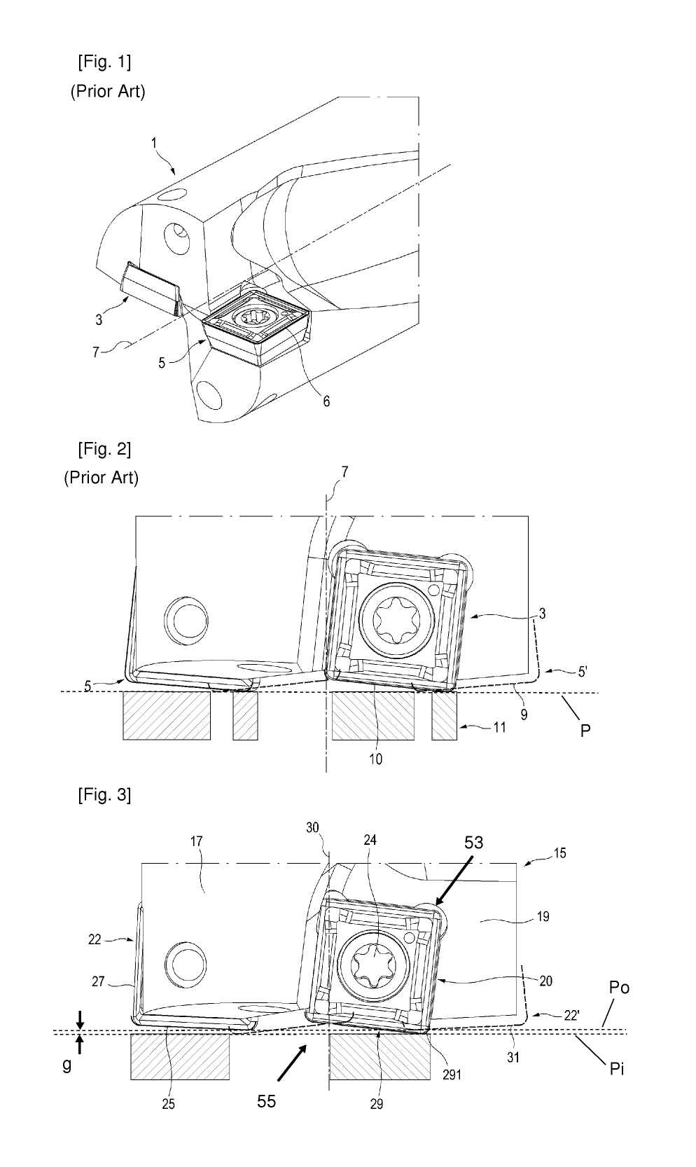

### MODE FOR THE INVENTION

Embodiments of the present invention will now be described in detail with reference to the accompanying drawings.

In describing the embodiments of the present invention by referring to the drawings, same reference numerals will be used for the same element. The description will be focused only on different portions so as to avoid any redundancy.

FIG. 3 illustrates an end of a drill 15 according to an embodiment of the present invention. The drill 15 comprises a body 17, an indexable inner cutting insert 20 and an indexable outer cutting insert 22. The body 17 is provided with chip flutes 19 for discharging chips, i.e., a chip flute for discharging chips generated by the cutting of the inner cutting insert 20 and a chip flute for discharging chips generated by the cutting of the outer cutting insert 22.

The end of the chip flute 19 is provided with an insert pocket for receiving the indexable inner cutting insert 20 and the outer cutting insert 22. The inner cutting insert 20 and the outer cutting insert 22 are firmly fixed to the insert pocket by a fixing means 24 such as a clamping screw.

The inner cutting insert 20 and the outer cutting insert 22 are disposed asymmetrically relative to the central axis 30 of the drill body 17. The inner cutting insert 20 is disposed relatively close to the central axis 30 of the drill body 17, while the outer cutting insert 22 is disposed relatively away from the central axis 30 of the drill body 17. The inner cutting insert 20 and the outer cutting insert 22 each have a lower cutting edge 29 and a lower cutting edge 25 disposed in the direction along which the drill body 17 proceeds during the drilling process. Accordingly, during the drilling process, the inner cutting insert 20 takes charge of cutting the portion around the center of a hole while the outer cutting insert 22 takes charge of cutting the portion around the outer circumference of the hole. In addition, the outer cutting insert 22 further comprises a side cutting edge 27 that takes charge of the side cutting together with the lower cutting edge 25 taking charge of depth cutting, and determines a drill diameter.

The inner cutting insert 20 and the outer cutting insert 22 have the same shape so that they can be compatibly used. Such a feature provides an advantage in terms of stock controlling of the insert.

As shown in FIG. 3, the lower cutting edge 29 of the inner cutting insert 20 is disposed lower than a lower cutting edge 31 of an imaginary cutting insert 22′ at a position where the inner cutting insert 20 is overlapped with the imaginary cutting insert 22′ in which the outer cutting insert 22 is rotated by approximately a half-turn relative to the central axis 30 (for better understanding, the amount of movement of the drill body in the vertical direction for the drilling process is not considered).

The present invention is thus structured to generate a strip of chip in a flute for discharging cutting chips from the inner cutting insert 20 during the cutting process of the inner cutting insert 20, as schematically shown in the shaded box in FIG. 3. Likewise, the outer cutting insert 22 is also structured to generate a strip of chip in a flute for discharging cutting chips from the outer cutting insert 22 during the cutting process of the outer cutting insert 22.

Moreover, as shown in FIG. 3, the inner cutting insert 20 is further moved to the inside in order to be disposed while going beyond the central axis 30 of the drill body 17 when seen from the front. Accordingly, the lowest portion 291 of the lower cutting edge 29 of the inner cutting insert 20 is disposed away from the central axis 30 in the radial direction of the drill body 17 at a distance of approximately a quarter of the drill diameter to thereby substantially equalize the width of the chip made by the inner cutting insert 20 and the width of the chip made by the outer cutting insert 22. By doing so, a more stable drilling can be ensured.

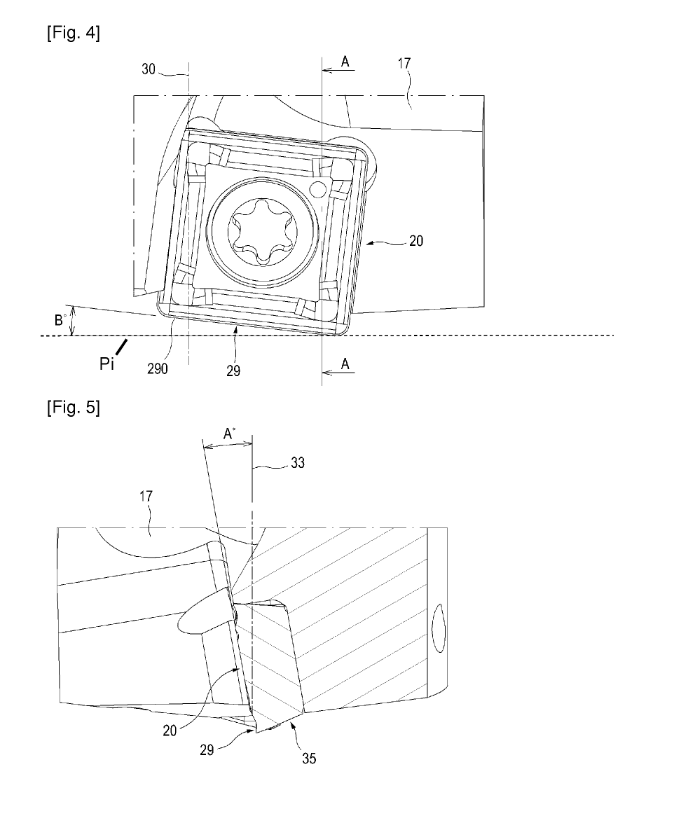

FIG. 4 is an enlarged view of the portion where the inner cutting insert 20 of the drill shown in FIG. 3 is mounted. As previously explained in relation to FIG. 3, the inner cutting insert 20 has the lower cutting edge 29 disposed in the direction along which the drill body 17 proceeds during the drilling process. The inner cutting insert 20 is disposed such that a considerable portion of the lower cutting edge 29 is slanted towards the proceeding direction of the body relative to the radial direction of the drill body 17. Said considerable portion of the lower cutting edge 29 in the present specification refers to the length that is substantially longer than a half of the entire length of the lower cutting edge 29. Said slanted disposition provides an advantage of reducing the load applied to the inner cutting insert 20 from the cutting surface of the workpiece during the drilling process. More importantly, it contributes to preventing the lower cutting edge 29 from interfering with the cutting surface of the workpiece.

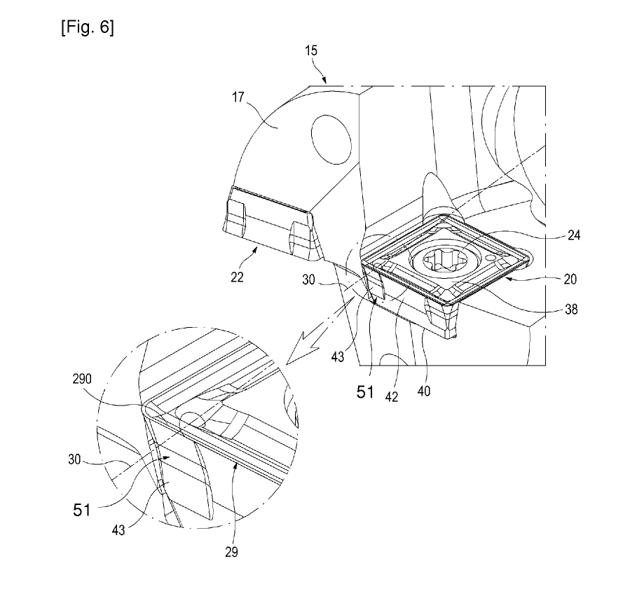

More specifically, as shown in FIG. 4, a portion 290 of the lower cutting edge 29 disposed beyond the central axis 30 of the drill body 17 rotates in the direction opposite to the expected rotational cutting direction as still being in the relation of the disposition beyond the central axis 30. As such, a portion 290 of the lower cutting edge 29 and its adjacent side surface 35 (shown in FIGS. 5 and 6) in the inner cutting insert 20 may easily come into interference with the cutting surface of the workpiece.

In the relevant prior art, there were always concerns that when the inner cutting insert is moved toward the inside beyond the central axis of the drill body, a portion of the cutting edge of the inner cutting insert beyond the central axis causes an interference with the workpiece during the drilling process, thereby damaging the cutting edge of the inner cutting insert. Moreover, in order to solve said problem, some efforts have been made in designing a drill in such a way that the cutting edge of the inner cutting insert is configured to have a predetermined curvature radius, or the drill is configured to be in a chamfering type, near the central axis of the drill body. However, such efforts cause the inner cutting insert and the outer cutting insert to be in different shapes, thereby causing other problems that are disadvantageous in terms of stock management of the insert.

However, as shown in FIG. 4, the present invention is structured such that a considerable portion of the lower cutting edge 29 of the inner cutting insert 20 is disposed with a slant towards the proceeding direction of the body 17 during the drilling process along the radial direction of the drill body 17, thereby remarkably reducing the interference effect with the cutting surface of the workpiece. In the slant disposition, the degree of slant of the considerable portion of the lower cutting edge 29 of the inner cutting insert 20 towards the direction along which the body 17 advances during the drilling process (see angle B in FIG. 4) is preferably between about 0° and 10°. If angle B becomes much greater than about 10°, then the lower cutting edge 29 disposed with a slant could be disadvantageously subjected to more loads applied from the cutting surface of the workpiece so that it becomes rather vulnerable.

Moreover, the aforementioned problems of the prior art regarding the interference between the cutting edge and a workpiece can be solved by the feature illustrated in FIG. 5. FIG. 5 is a cross-sectional view of the drill shown in FIG. 4 when taken along line A-A in FIG. 4. The inner cutting insert 20 is disposed so as to have a negative axial angle relative to the axial line 33 parallel to the central axis 30 of the drill body 17. More specifically, as shown in FIG. 5, the inner cutting insert 20 is disposed such that the upper portion thereof is slanted towards the rotational direction of the inner cutting insert 20.

According to this structure, the side surface 35 of the inner cutting insert 20 ensures a considerable space relative to the cutting surface, thereby remarkably reducing a possible interference between the portion 290 of the lower cutting edge 29 disposed beyond the central axis 30 of the drill body 17 and its adjacent side surface 35. The negative axial angle (see angle A in FIG. 5) of the inner cutting insert 20 preferably ranges about 0°˜10°. When angle A becomes much greater than about 10°, the lower cutting edge 29 could be subjected to more loads applied from the cutting surface, thus causing a disadvantage of becoming more vulnerable.

FIG. 6 is a perspective view of the drill according to another embodiment of the present invention. The drill shown in FIG. 6 further comprises an additional feature to the inner cutting insert 20, in addition to the features explained with regard to FIGS. 4 and 5 above. The inner cutting insert 20 is generally in a rectangular parallelepiped shape and comprises: a top surface 38 and a bottom surface 40 through which a clamping screw 24 passes; and four side surfaces 42 that connect the top surface 38 to the bottom surface 40. The four side surfaces 42 comprise four edges having rotatably operable cutting edges. The side surface 42 has a side surface 35 adjacent to the cutting edge 290 disposed beyond the central axis 30 of the drill body 17, wherein the side surface 35 further comprises a recess 43. The recess 43 has a concave shape so as to actively reduce more of the interference effect. Thus, the probable interference between the cutting surface of a workpiece and the portion 290 of the lower cutting edge 29 disposed beyond the central axis 30 of the drill body 17 as well as its adjacent side surface 35 may be more reduced in the inner cutting insert 20.

Although the technical features explained in relation to FIGS. 4, 5 and 6 are most preferable when all the features are used in combination, a drill comprising one or two features together may provide the effect of reducing the probable interference between the workpiece and a portion of the cutting edge of the inner cutting insert disposed beyond the central axis.

Thus, according to the embodiments of the present invention as stated above, the inner cutting insert can be disposed more downwardly and internally beyond the central axis of the drill body compared to the relevant prior art. Accordingly, it is possible to provide a cutting tool for drilling, which employs inserts in the same shape both for the inner cutting insert and the outer cutting insert while being capable of discharging a strip of chip in one chip flute.

It is also possible to properly place the inner cutting insert and the outer cutting insert in such a way that they are subjected to a substantially equal cutting load. As a result, it is possible to discharge a chip having a substantially equal width as schematically shown in the shaded box in FIG. 3. In such a case, it is possible to achieve a more stable drilling during the drilling process and the cutting performance can be also dramatically enhanced.

The foregoing is only preferable embodiments of the present invention, which are only exemplary. Thus, it would be understood by a person skilled in the art that the invention may be modified in various ways from the embodiments without departing from the scope of the subject matter of the present invention.

1. A cutting tool for drilling, comprising:
a body having a lower end facing a direction of drilling, a central axis of rotation and chip flutes; and
indexable inner and outer cutting inserts each disposed in an insert pocket formed at an end of the chip flute; wherein:
the inner cutting insert is located closer to the central axis of the body than the outer cutting insert, the inner and outer cutting inserts having a same shape and including lower cutting edges disposed in the direction of drilling;
the inner cutting insert is overlapped with an imaginary cutting insert located in a position where the outer cutting insert is rotated by approximately a half turn relative to the central axis, the lower cutting edge of the inner cutting insert being disposed in a position lower than that of the imaginary cutting insert in an overlapped portion; and
a lowest portion of the lower cutting edge of the inner cutting insert is disposed approximately one quarter of a drill diameter away from the central axis in a radial direction of the body.

2. The cutting tool for drilling of claim 1, wherein the lower cutting edge of the inner cutting insert is slanted towards the direction of drilling along a radially outward direction of the body.

3. The cutting tool for drilling of claim 2, wherein the lower cutting edge of the inner cutting insert is slanted in an angle of about 0° to 10° relative to a horizontal plane which is perpendicular to the central axis of the body.

4. The cutting tool for drilling of claim 2, wherein the inner cutting insert is disposed to have a negative axial angle relative to an axis parallel to the central axis.

5. The cutting tool for drilling of claim 4, wherein the negative axial angle of the inner cutting insert is about 0° to 10°.

6. The cutting tool for drilling of claim 1, wherein a portion of the inner cutting insert is disposed beyond the central axis of the body.

7. The cutting tool for drilling of claim 6, wherein:
the cutting insert has a generally rectangular parallel-piped shape and upper and lower surfaces through which a clamping screw passes;
the cutting insert further has four side surfaces for connecting the upper surface to the lower surface; and
recesses are formed on portions of the side surfaces.

8. The cutting tool for drilling of claim 7, wherein the recesses are formed on side portions of the side surfaces, the side portions being disposed beyond the central axis of the body.

9. A cutting tool for drilling, comprising:
a body having a lower end facing a direction of drilling, a central axis of rotation and chip flutes; and
indexable inner and outer cutting inserts disposed in an insert pocket formed at an end of the chip flute; wherein:
the inner cutting insert is located closer to a central axis of the body than the outer cutting insert, the inner and outer cutting inserts having a same shape and including lower cutting edges disposed in the direction of drilling;
the inner cutting insert is overlapped with an imaginary cutting insert located in a position where the outer cutting insert is rotated by approximately a half turn relative to the central axis, the lower cutting edge of the inner cutting insert being disposed in a position lower than that of the imaginary cutting insert in an overlapped portion;
a lowest portion of the lower cutting edge of the inner cutting insert is disposed by approximately one quarter of a drill diameter away from the central axis in a radial direction of the body; wherein
the lower cutting edge of the inner cutting insert is slanted towards the direction of drilling along a radially outward direction of the body; and
the inner cutting insert is disposed to have a negative axial angle relative to an axis parallel to the central axis of the body; and
the cutting insert has a generally rectangular parallel-piped shape and upper and lower surfaces through which a clamping screw passes;
the cutting insert further has four side surfaces for connecting the upper surface to the lower surface; and
recesses are formed on portions of the side surfaces.

10. The cutting tool for drilling of claim 9, wherein:
the lower cutting edge of the inner cutting insert is slanted in an angle of about 0° to 10° relative to a horizontal plane which is perpendicular to the central axis of the body, and
the negative axial angle of the inner cutting insert is about 0° to 10°.

11. A cutting tool for drilling, comprising:
a body having a lower end facing a direction of drilling, a central axis of rotation and chip flutes; and
indexable inner and outer cutting inserts each disposed in an insert pocket formed at an end of the chip flute; wherein:
the inner cutting insert is located closer to the central axis of the body than the outer cutting insert, the inner and outer cutting inserts having a same shape and including lower cutting edges disposed in the direction of drilling;
a lowermost portion of inner cutting insert extends to an axially lowermost first horizontal plane that is perpendicular to the central axis, while a lowermost portion of the outer cutting insert only extends to an axially rearward second horizontal plane which is also perpendicular to the central axis and is spaced apart from the first horizontal plane by a gap; and
a lowest portion of the lower cutting edge of the inner cutting insert is disposed by approximately one quarter of a drill diameter away from the central axis in a radial direction of the body.

12. The cutting tool for drilling of claim 11, wherein the lower cutting edge of the inner cutting insert is slanted towards the direction of drilling along a radially outward direction of the body.

13. The cutting tool for drilling of claim 12, wherein the lower cutting edge of the inner cutting insert is slanted in an angle of about 0° to 10° relative to a horizontal plane which is perpendicular to the central axis of the body.

14. The cutting tool for drilling of claim 12, wherein the inner cutting insert is disposed to have a negative axial angle relative to an axis parallel to the central axis.

15. The cutting tool for drilling of claim 14, wherein the negative axial angle of the inner cutting insert is about 0° to 10°.

16. The cutting tool for drilling of claim 11, wherein a portion of the inner cutting insert is disposed beyond the central axis of the body.

17. The cutting tool for drilling of claim 16, wherein:
the cutting insert has a generally rectangular parallel-piped shape and upper and lower surfaces through which a clamping screw passes;
the cutting insert further has four side surfaces for connecting the upper surface to the lower surface; and
recesses are formed on portions of the side surfaces.

18. The cutting tool for drilling of claim 17, wherein the recesses are formed on side portions of the side surfaces, the side portions being disposed beyond the central axis of the body.
